(19) United States
(12) Patent Application Publication
(10) Pub. No.: US 2014/0293151 A1
(43) Pub. Date: Oct. 2, 2014

(54) Touch Panel and Manufacturing Method Thereof

(71) Applicant: Nanchang O-Film Tech. Co., Ltd., Nanchang (CN)

(72) Inventor: Zhao He, Nanchang (CN)

(73) Assignee: Nanchang O-Film Tech. Co., Ltd., Nanchang (CN)

(21) Appl. No.: 14/000,048

(22) PCT Filed: Jul. 8, 2013
(86) PCT No.: PCT/CN2013/078969

§ 371 Date: Aug. 16, 2013

(30) Foreign Application Priority Data
Mar. 8, 2013 (CN) 201310074824.9

(51) Int. Cl. G06F 1/16

(52) U.S. Cl. CPC G06F 1/1692
USPC 349/12; 29/622

(57) ABSTRACT

A touch panel includes: a first transparent insulating substrate; a second transparent insulating substrate, comprising a first surface which is faced to the first transparent insulating substrate and a second surface opposite to the first surface; a sensing electrode layer, disposed between the first transparent insulating substrate and the second insulating substrate, the sensing electrode layer comprising a plurality of independently disposed sensing electrodes; and a driving electrode layer, disposed on the first surface or the second surface of the second transparent insulating layer, the driving electrode layer comprising a plurality of independently disposed driving electrodes, each driving electrode comprising a meshed conductive circuit. A method of manufacturing a touch panel is also disclosed. The touch panel has a lower cost and a higher sensitivity.

### FIELD OF THE INVENTION

The present disclosure relates to a field of touch technology, and more particularly relates to a touch panel and a manufacturing method thereof.

### BACKGROUND OF THE INVENTION

Touch panel is widely used in various kinds of electronic devices with screens, such as computers or electronic devices which include smart phone, TV, PDA, tablet PCs, notebook computers, machine tools with industrial display touch, integrated computers and ultra books, etc. The touch panel can be divided into a capacitive touch panel, a resistive touch panel and a surface wave touch panel etc. according to a working principle.

The capacitive touch panel functions by utilizing the induced current of a human body. When a finger touches the touch panel, the user and a surface of the capacitive touch panel form a coupling capacitor due to a body electric field, for a high frequency current, the capacitor is a conductor, a small current pass through from the contact point of the finger. The current flow out from the electrodes located in four corners of the capacitive touch panel, and the current pass through the four electrodes is proportional to the distance between the finger and four corners, the four current ratios are precisely calculated by a controller to get a position of the touch point.

All current touch panels are using ITO (indium tin oxide) glass or ITO film (i.e. formed on the glass or on the film) to form patterns of driving electrodes and sensing electrodes. But the driving electrode and sensing electrode patterns formed by the ITO glass or ITO film have the following disadvantages: on one hand, the ITO driving electrode or sensing electrode bulges on the surface of the glass or transparent film, it is easy to be scratched or peeled off, which would lead to the decrease of the production yield; on the other hand, the main material of ITO glass or ITO film is a rare metal of indium, the indium is rare, so the cost is high, and a resistance or a surface resistance of a large size touch ITO panel is large, which affects the signal transmission speed and results in poor touch sensitivity, thus affecting the electronic product functions, and the user experiences are poor.

### SUMMARY OF THE INVENTION

The present disclosure is directed to provide a touch panel with low cost and high sensitivity.

In addition, according to an aspect of the present disclosure, a manufacturing method of a touch panel is provided.

A touch panel includes: a first transparent insulating substrate; a second transparent insulating substrate, comprising a first surface which is faced to the first transparent insulating substrate and a second surface which is opposite to the first surface; a sensing electrode layer, disposed between the first transparent insulating substrate and the second insulating substrate, the sensing electrode layer comprises a plurality of independently disposed sensing electrodes; and a driving electrode layer, disposed on the first surface or the second surface of the second transparent insulating layer, the driving electrode layer comprises a plurality of independently disposed driving electrodes, each driving electrode comprises a meshed conductive circuit.

A touch panel, includes: a rigid transparent insulating substrate; a sensing electrode layer, formed on a surface of the rigid transparent insulating substrate, comprising a plurality of independently disposed sensing electrodes; a flexible transparent insulating substrate, comprising a first surface and a second surface which is opposite to the first surface, and a driving electrode layer, formed on the first surface or the second surface of the flexible transparent insulating substrate [the sensing electrode layer] comprising a plurality of independently disposed driving electrodes, each driving electrode of the driving electrode layer comprises a [meshed conductive circuit]; the first surface or the second surface of the flexible transparent insulating substrate is attached to the rigid transparent insulating substrate.

A method of manufacturing a touch panel, includes the following steps: providing a transparent insulating substrate; forming a sensing electrode layer on a surface of the first transparent insulating substrate; providing a second transparent insulating substrate; forming a driving electrode layer on a surface of the second transparent insulating substrate; a driving electrode of the driving electrode layer is a meshed conductive circuit which comprises a plurality of mesh cells; and attaching the second transparent insulating substrate to the first transparent insulating substrate.

A method of manufacturing a touch panel, includes the following steps: providing a first transparent insulating substrate; providing a second transparent insulating substrate; forming a driving electrode layer on one surface of the second transparent insulating substrate; an electrode of the driving electrode layer being a meshed conductive circuit comprising a large number of mesh cells; forming a sensing electrode layer on the other surface of the second transparent insulating substrate; and attaching the first transparent insulating substrate to the second transparent insulating substrate.

The driving electrode of the touch panel is manufactured to a conductive mesh formed by the meshed conductive circuit in the above method, the touch panel do not have the problems that the surface is easy to be scratched or peeled off, the cost is high, the surface resistance is high for a large size panel when the ITO film is used, so the cost of the touch panel is low, the sensitivity is higher.

### BRIEF DESCRIPTION OF THE DRAWINGS

FIG. 1 is a schematic view of an electronic device having a touch panel of the present disclosure.

FIG. 2 is a cross sectional view of a first type touch panels of the present disclosure.

FIG. 3 is a cross sectional view of an embodiment of FIG. 2.

FIG. 4 is a schematic plan view of a driving electrode layer of FIG. 3 forming a surface of a second transparent insulating layer.

FIG. 5 is a sectional view taken along the profile line a-a′ of FIG. 4.

FIG. 6 is a sectional view taken along the profile line b-b′ of FIG. 4.

FIG. 7 is a schematic plan view of a sensing electrode layer of FIG. 3 forming a surface of a transparent insulating substrate.

FIG. 8 is a sectional view taken along the profile line A-A′ of FIG. 7.

FIG. 9 is a sectional view taken along the profile line B-B′ of FIG. 7.

FIG. 10 is a cross sectional view of a second type touch panels of the present disclosure.

FIG. 11 is a cross sectional view of a specific embodiment shown in FIG. 10.

FIG. 12 is a cross sectional view of a third type touch panels of the present disclosure.

FIG. 13 is a cross sectional view of a specific embodiment shown in FIG. 12.

FIG. 14 is a cross sectional view of a specific embodiment of fourth type touch panels of the present disclosure.

FIG. 15a and FIG. 15b are schematic views of arrangements and shapes of the sensing electrodes and driving electrodes.

FIG. 16a, FIG. 16b, FIG. 16c and FIG. 16d are partially enlarged views correspond to part A of FIG. 15a or part B of FIG. 15b respectively in accordance with one embodiment.

FIG. 17 is a flowchart of a method of manufacturing the touch panel in accordance with one embodiment.

FIG. 18 is a specific flowchart of step 104 of a process shown in FIG. 17.

FIG. 19 is a layered structure of the driving electrode layer obtained according to step 104 of a process shown in FIG. 17.

FIG. 20 is a flowchart of a method of manufacturing the touch panel in accordance with another embodiment.

FIG. 21 is a specific flowchart of step S202 of a process shown in FIG. 20.

### DETAILED DESCRIPTION OF THE EMBODIMENTS

Illustrative embodiments of the disclosure are described below. The following explanation provides specific details for a thorough understanding of and enabling description for these embodiments. One skilled in the art will understand that the disclosure may be practiced without such details. In other instances, well-known structures and functions have not been shown or described in detail to avoid unnecessarily obscuring the description of the embodiments.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

The “transparent” described in the transparent insulating substrate of the present disclosure can be explained as “transparent” or “substantially transparent”; the insulating in the transparent insulating substrate can be explained as “insulating” or “dielectric”. So the “transparent insulating substrate” of the present invention can be explained as but not limited to transparent insulating substrate, substantially transparent insulating substrate, transparent dielectric substrate and substantially dielectric substrate.

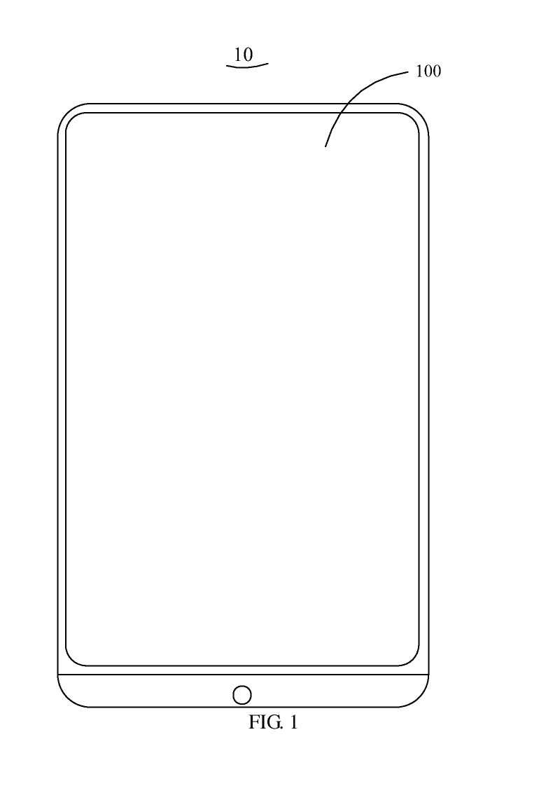

FIG. 1 shows one embodiment of an electronic device having a touch panel of the present disclosure, the electronic device 10 is a smart phone or a tablet PC. The touch panel 100 of the electronic device 10 is bonded to an upper surface of a LCD (Liquid Crystal Display) screen, which is used in one of I/O devices of an electronic device human computer interaction. It is to be understood that the touch panel 100 of the present disclosure can also be applied to electronic devices such as a mobile phone, a mobile communication phone, a TV, a tablet PC, a notebook computer, a machine tool with a touch display screen, a GPS equipment, an integrated computer and an ultra book.

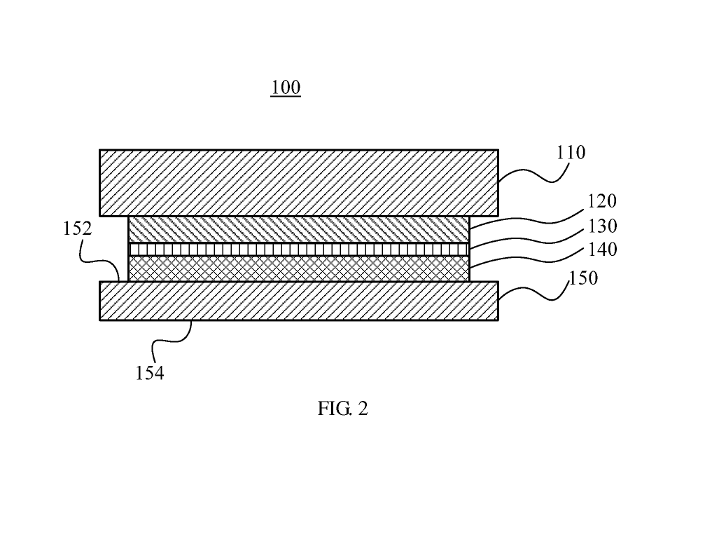

FIG. 2 is a cross-sectional view of the first type embodiments of the touch panel of the present disclosure. The touch panel 100 includes a first transparent insulating substrate 110, a sensing electrode layer 120, an adhesive layer 130, a driving electrode layer 140, and a second transparent insulating substrate 150. The sensing electrode layer 120 is disposed between the first transparent insulating substrate 110 and the second transparent insulating substrate 150. The second transparent insulating substrate 150 includes a first surface 152 which is faced to the first transparent insulating substrate 110, and a second surface 154 opposite to the first surface 152. The driving electrode layer 150 is formed on the first surface 152. In the alternative embodiments, the driving electrode layer 150 can also be configured on the second surface 154.

The adhesive layer 130 is applied to bond the first transparent insulating substrate 110 and the second transparent insulating substrate 150 as a component. When the driving electrode layer 150 is disposed on the first surface 152, the adhesive layer 130 is used to insulate the sensing electrode layer 120 from the driving electrode layer 140. The adhesive layer can be an optically transparent OCA (optical clear adhesive) or a LOCA (liquid optical clear adhesive).

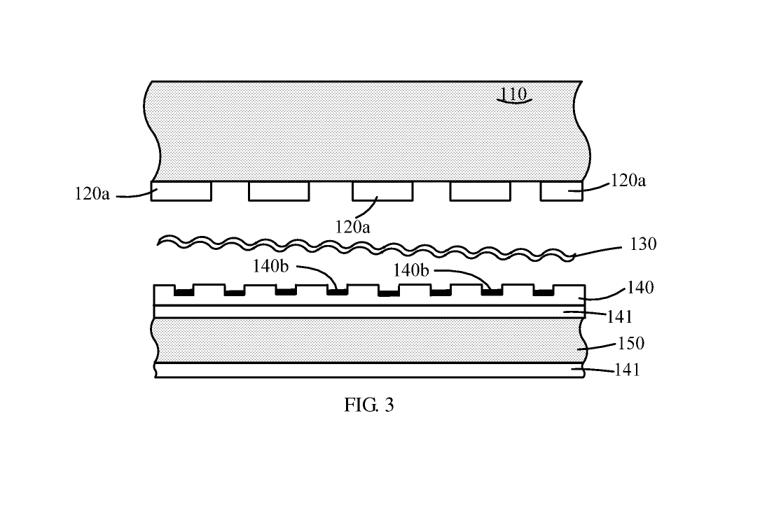

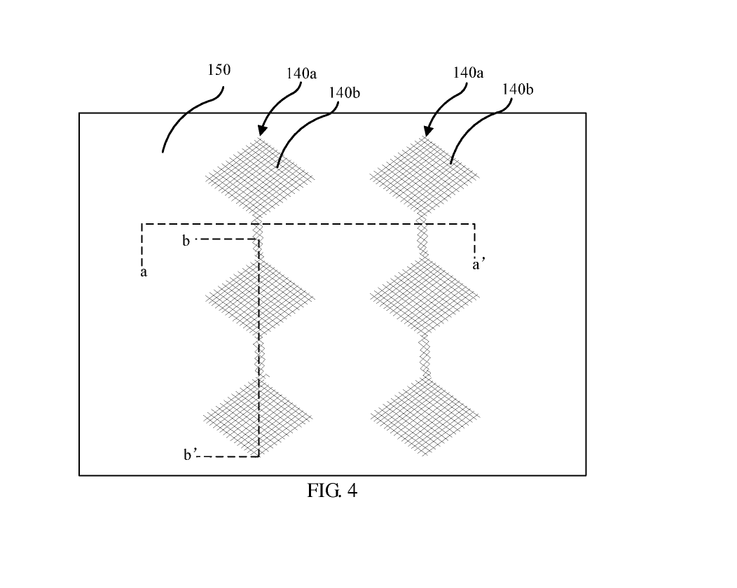

FIG. 3 is a cross sectional view of a first type touch panels in accordance with a specific embodiment. The sensing electrode layer 120 includes a plurality of independently disposed sensing electrodes 120a. Referring also to FIG. 4, the driving electrode layer 140 includes a plurality of independently disposed driving electrodes 140a; each of the driving electrodes 140a includes a meshed conductive circuit 140b. “Independently disposed” described herein can be understood but not limit to several explanations of “independently disposed”, “spaced disposed” or “insulated disposed”.

In the capacitive touch panel, the sensing electrode and driving electrode are essential two elements of the touch panel. The sensing electrodes are usually close to a touch surface of the touch panel, the driving electrodes are away from the touch surface. The driving electrodes are connected to a scanning signal generating device, the scanning signal device provides a scanning signal, and the sensing electrodes generate changed parameters when it is touched by a charged conductor to sense the touch position of the sensing region.

Each of the sensing electrodes of the sensing electrode layer 120 is electrically connected to a peripheral sensing detection processing module of the touch panel, each of the driving electrodes of the driving electrode layer 140 is electrically connected to the peripheral excitation signal module of the touch panel, and the sensing electrodes and the driving electrodes form a mutual capacitor therebetween. When the surface of the touch panel is touched by a touch operation or multi-touches, the mutual conductance of the touch center region will change, the touch operation is converted into an electrical signal, a coordinate data of the touch center region can be obtained by processing the data of the capacitance variation region, the electronic device which can process the related data gets the corresponding exact position of the touch operation on a screen attached to the touch panel according to the coordinate of the touch center region, thus the corresponding function and input operation can be completed.

In the illustrated embodiment, the sensing electrode layer 120 and the driving electrode layer 140 of the present disclosure are manufactured by different ways, different materials and different manufacturing processes.

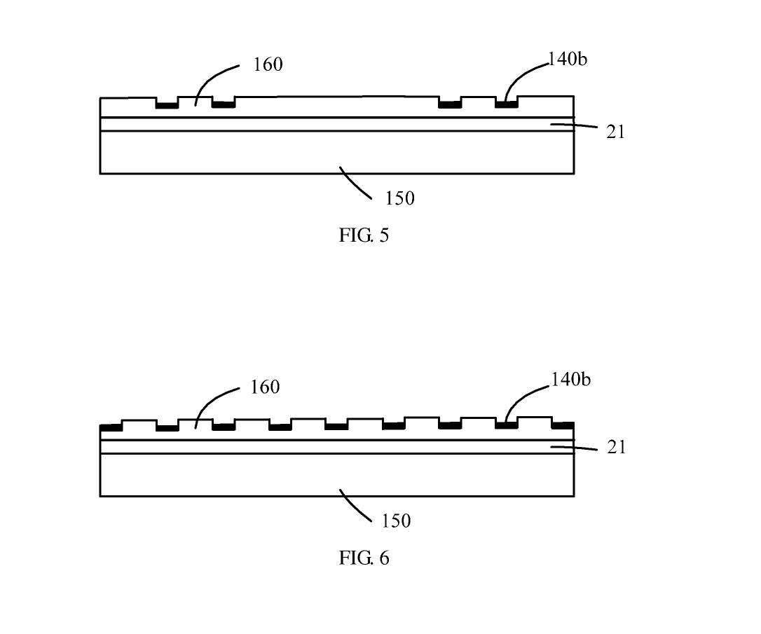

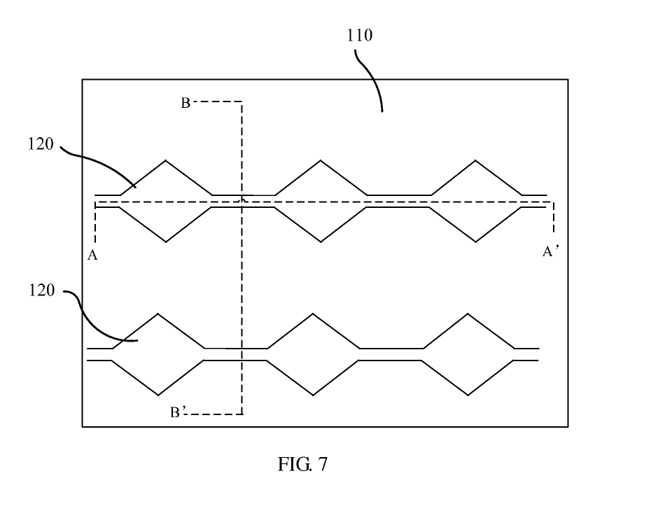

Specifically, both FIG. 5 and FIG. 6 are cross-sectional views taken along the profile lines of a-a′ and b-b′ respectively. The driving electrode layer 140 includes a plurality of independently disposed meshed conductive circuits 140b. The meshed conductive circuits 140b are embedded or buried in the transparent insulating layer 160; the transparent insulating layer 160 is attached to a surface of the second transparent isolating substrate 150 by a tackifier layer. The meshed conductive circuits 140b are made of a material selected from a group consisting of gold, silver, copper, aluminum, zinc, gold-plated silver and alloys of at least two above metals. The above materials are easy to obtain and have low cost, especially the meshed conductive circuit 140b made of conductive silver paste has good conductivity and low cost.

It is easy to be understood that there are several ways that the meshed conductive circuit 140b is embedded or buried in the transparent insulating layer 160. In one preferred embodiment, a plurality of interlaced grid trenches are configured on the transparent insulating layer 160, the meshed conductive circuit 140b is received in the trenches, thus the conductive grid circuit 140b is embedded or buried in the surface layer of the transparent insulating layer 120. In the process of moving or handling, because the driving electrode 140a is firmly attached to the second transparent insulating substrate 150, it is not easy to be damaged or peeled off. It is easy to be known that the meshed conductive circuit 140b can also be directly embedded or buried in a surface of the second transparent insulating substrate 150.

Specifically, a mesh spacing of the meshed conductive circuit 140b is defined as d₁, and 100 μm≦d₁<600 μm, a surface resistance of the meshed conductive circuit is defined as R, and 0.1 Ω/sq≦R<200 Ω/sq.

The surface resistance R of the meshed conductive circuit 140b affects the transmission speed of the current signal, thus affecting the responsiveness of the touch panel. Therefore, the surface resistance R of the meshed conductive circuit 140b is preferably defined as 1 Ω/sq≦R≦60 Ω/sq. The surface resistance R in this range can significantly increase the conductivity of the conductive film and significantly improve the signal transmission speed, and the accuracy requirement is lower compared to that of the surface resistance of 0.1 Ω/sq≦R<200 Ω/sq, the technical requirement is reduced on the premise of ensuring conductivity, the cost is reduced. It is to be understood in the manufacturing process, the surface resistance of meshed conductive circuit 140b (R) is codetermined by several factors of the mesh spacing, material, traces diameter (traces width).

The mesh traces width of the meshed conductive circuit 140b is defined as d₂ and 1 μm≦d₂≦10 μm. The traces width of the mesh affects the transmittance of the conductive film, the smaller the traces width, the better the transmittance. When the mesh traces spacing d₁ of the meshed conductive circuit is defined as 100 μm≦d₁<600 μm, the surface resistance R of the meshed conductive circuit 140b is defined as 0.1 Ω/sq≦R<200 Ω/sq, the mesh traces width d₂ is defined as 1 μm≦d₂≦10 μm which can satisfy the requirement, and can at the same time enhance the transmittance of the touch panel. Especially when the mesh traces width d₂ of the meshed conductive circuit 140b is defined as 2 μm≦d₂<5 μm, the larger the transmittance area, the better the transmittance, and the accuracy requirement is relatively low.

In the preferred embodiments, the meshed conductive circuit is made of silver, and it uses the regular pattern, the mesh traces spacing ranges from 200 μm to 500 μm, the surface resistance of the meshed conductive circuit is 4 Ω/sq≦R<50 Ω/sq, the coating amount of silver ranges from 0.7 g/m² to 1.1 g/m².

In a first embodiment, d₁=200 μm, R=4 to 5 Ω/sq, the silver amount is 1.1 g/m², the mesh traces width d₂ ranges from 500 nm to 5 μm. It is to be understood, a value of the surface resistance R, an amount of silver would be affected by the mesh traces width d₂ and filling trench depth, the larger the mesh traces width d₂, the larger the filling trench depth, the surface resistance would increase, the silver amount would also increase.

In a second embodiment, d₁=300 μm, R=10 Ω/sq, the silver amount ranges from 0.9 to 1.1 g/m², the mesh traces width d₂ ranges from 500 nm to 5 μm. It is to be understood, a value of the surface resistance R, an amount of the silver would be affected by the mesh traces width d₂ and filling trench depth, the larger the mesh traces width d₂, the larger the filling trench depth, the surface resistance would increase, the silver amount would also increase.

In a third embodiment, d₁=500 μm, R=30 to 40 Ω/sq, the silver amount is 0.7 g/m², the mesh traces width d₂ ranges from 500 nm to 5 μm. It is to be understood, a value of the surface resistance R, an amount of the silver would be affected by the mesh traces width d₂ and filling trench depth, the larger the mesh traces width d₂, the larger the filling trench depth, the surface resistance would increase; the silver amount would also increase.

It is to be understood that may also be made of a material selected from a group consisting of transparent conductive polymers, carbon nano-tubes and graphene, except that the meshed conductive circuit 140b is made of metal conductive materials.

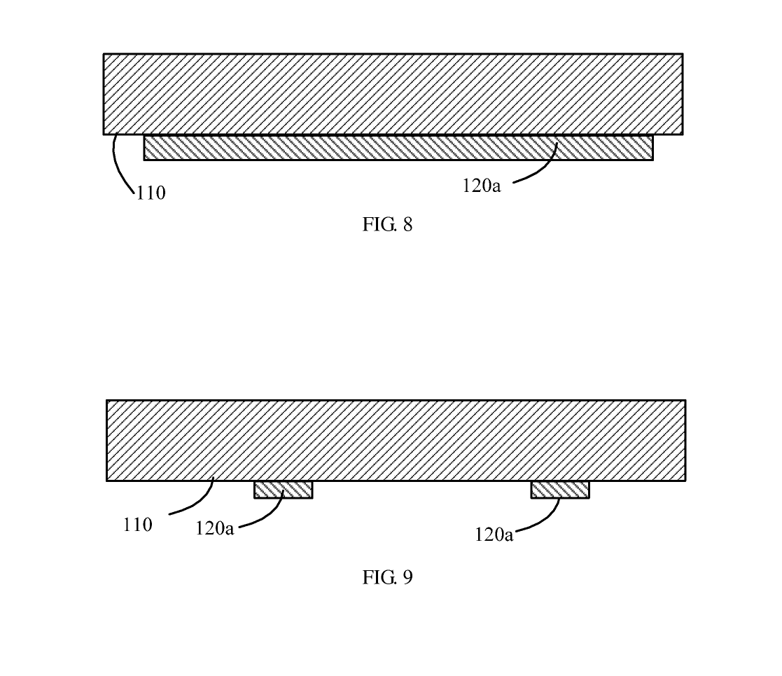

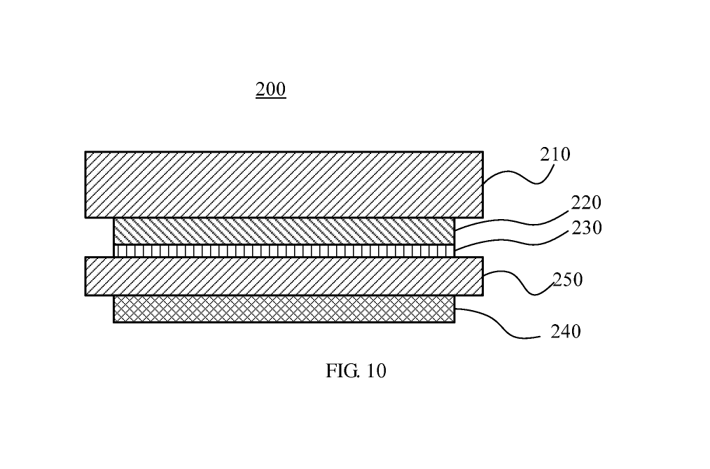

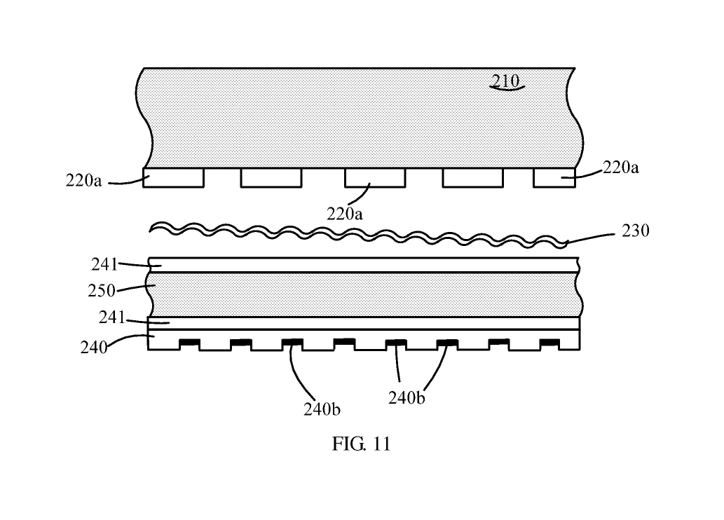

Referring to FIG. 7, FIG. 8 and FIG. 9, the sensing electrode of the sensing electrode layer 120 is made of a material selected from a group consisting of the ITO (indium tin oxide), ATO (antimony doped tin oxide), IZO (indium zinc oxide), AZO (aluminum zinc oxide), PEDOT (polyethylene dioxythiophene), transparent conductive polymer, grapheme and carbon nano tube. A patterned sensing electrode is formed by engineering processes of etching, printing, coating, lithography and photolithography, i.e. a plurality of independently disposed transparent sensing electrodes.

In the illustrated embodiment, the sensing electrode layer 120 is directly formed on a surface of the rigid transparent insulating substrate 110, and the rigid transparent insulating substrate 110 is a rigid substrate. Specifically, the rigid substrate includes strengthened glass or hardening transparent plastic plate, which is strengthened glass or reinforced plastic plate for short. The strengthened glass includes functional layers with functions of anti-glaring, hardening, antireflection or anti-fogging. The functional layer with functions of anti-glaring or anti-fogging is formed by coating paint with functions of anti-glaring or anti-fogging, the paint includes metal oxide particles; the functional layer with hardening function is formed by coating polymer paint with hardening function or by directly harden by a chemical or physical method; functional layer with antireflection function is a titania coating, a magnesium fluoride coating or a calcium fluoride coating. It is to be understood, a plastic plate with good transmittance can be manufactured to the rigid transparent substrate according to a processing method of the strengthened glass.

Referring to FIG. 3, the second transparent insulating substrate 150 is made of a flexible material, such as made of a material selected from a group consisting of flexible polyethylene terephthalate (PET), polycarbonate (PC), polyethylene (PE), polyvinyl chloride (PVC), polypropylene (PP), polystyrene (PS) or polymethyl methacrylate methyl ester (PMMA). Besides, in order to increase a adhesive strength of the of the second transparent insulating substrate 150, the first surface or second surface of the transparent insulating substrate 150 are provided with a tackifier layers 141, which facilitates a firmly attaching of the transparent insulating layer to the second transparent insulating substrate 150. What to be illustrated is that because the second transparent insulating substrate 150 is made of a flexible material, in a process of moving and handling, the flexible material is inevitably deformed or bent, the using of an embedded or buried driving electrode is more reliable.

In one specific embodiment of the first type embodiments of the touch panel of the present disclosure, the first transparent insulating substrate 110 is made of strengthened glass, the second transparent insulating substrate 150 is made of plastics polyethylene terephthalate (PET), an ITO sensing electrode layer is formed on the strengthened glass, the driving layer including a meshed conductive circuit is formed on a surface of the of the PET substrate, then a PET flexible substrate is attached to the first insulating substrate 110 made of strengthened glass, the flexible substrate is attached to the strengthened glass in a convenient way in the above embodiment to manufacture the touch panel of the present disclosure. The above manufacturing process is simple, besides the thickness of the touch panel is reduced.

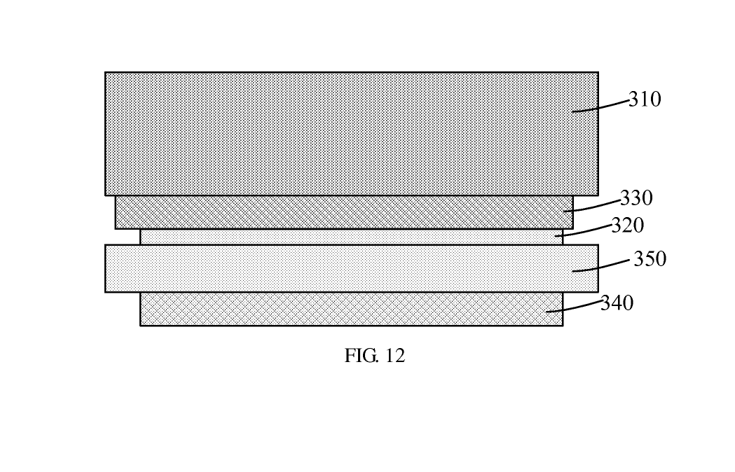

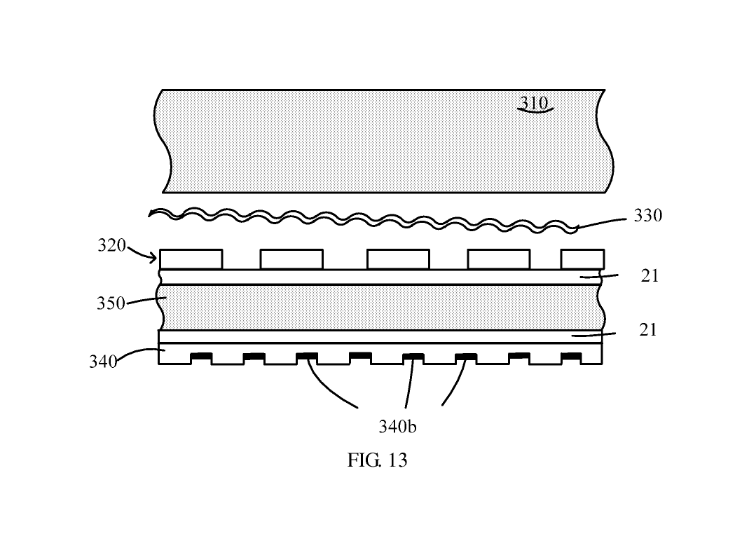

FIG. 10 and FIG. 11 show a cross sectional view of the second type touch panels and a cross sectional view of a specific embodiment respectively. The difference between the present type embodiments and the first type embodiments are: the driving electrode layer 240 is disposed on a second surface of the second transparent insulating substrate 250, or in other word, compared to the first type touch panels, a back side of the second transparent insulating substrate 250 with the driving electrode layer 240 is attached to the first transparent insulating substrate 210 as one. Forming methods of the sensing electrode layer 220 and the driving electrode layer 240 are different from that of the first type embodiments.

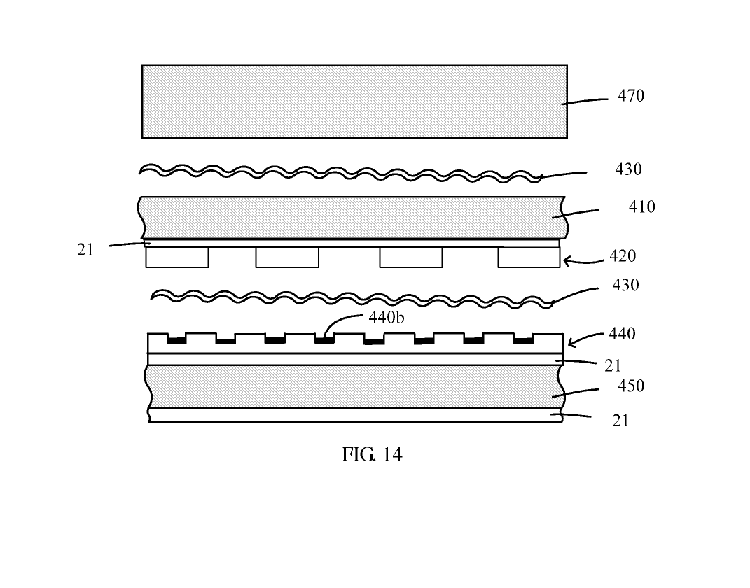

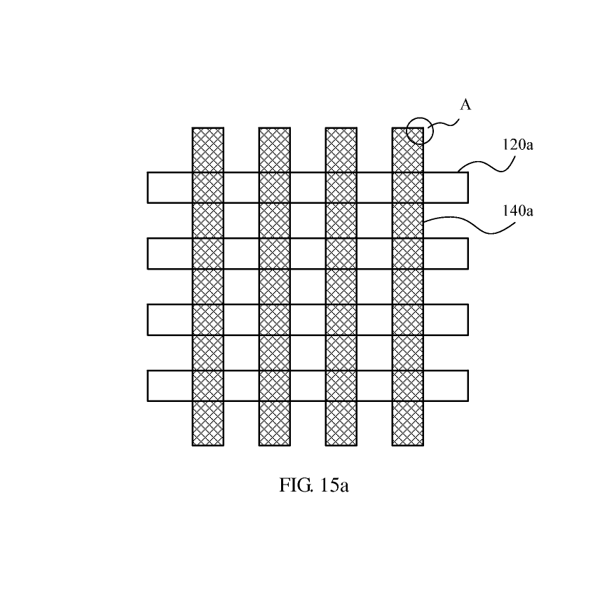

FIG. 12 and FIG. 13 show a cross sectional view of the touch panel of third type embodiments of the present disclosure and a cross sectional view of a specific embodiment respectively. Compared to the first type embodiments, the sensing electrode layer 320 is formed on the first surface of the second transparent insulating substrate 350, the driving electrode layer is formed on the second surface of the second transparent insulating substrate 350, i.e. it is a DITO structure. The driving electrode layer 340 includes a meshed conductive circuit 340b. The DITO structure is attached to the first transparent insulating substrate 310 by the adhesive layer 330. In the present type embodiments, the first transparent insulating substrate 310 is made of a material selected from a group consisting of strengthened glass, flexible polyethylene terephthalate (PET), polycarbonate (PC), polyethylene (PE), polyvinyl chloride (PVC), polypropylene (PP), polystyrene (PS) or poly methyl methacrylate (PMMA).

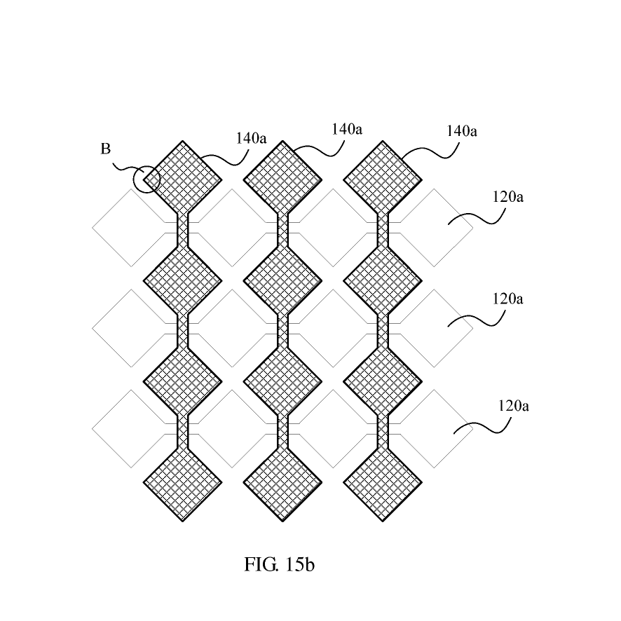

FIG. 14 is a cross sectional view of fourth type embodiments of the present disclosure. The touch panel comprises sequentially stacked a second transparent insulating substrate 450, a driving electrode layer 440, a adhesive layer 430, a sensing electrode layer 420, a first transparent insulating substrate 430 and a third transparent insulating substrate 470. The sensing electrode layer 420 is bonded to the first transparent insulating substrate 410 by the tackifier layer 21; the driving electrode layer 440 is bonded to the second transparent insulating substrate 450 by the tackifier layer 21. The driving electrode layer 440 includes a meshed conductive circuit 440b. Compared to the above three type embodiments, the third transparent insulating substrate 470 is also included in the present type embodiments, the third transparent insulating substrate 470 is a strengthened glass plate or a flexible transparent plate. The flexible transparent plate is made of a material selected from a group consisting of flexible polyethylene terephthalate (PET), polycarbonate (PC), polyethylene (PE), polyvinyl chloride (PVC), polypropylene (PP), polystyrene (PS) or polymethyl methacrylate methyl ester (PMMA).

The differences between the present type embodiments and the above three type embodiments are: the first transparent insulating substrate 410 and the second transparent insulating substrate 450 are made of a material selected from a group consisting of strengthened glass, flexible polyethylene terephthalate (PET), polycarbonate (PC), polyethylene (PE), polyvinyl chloride (PVC), polypropylene (PP), polystyrene (PS) and polymethyl methacrylate methyl ester (PMMA). In a preferred embodiment, the first transparent insulating substrate 410 and the second transparent insulating substrate are flexible substrates, such as they are made of PET.

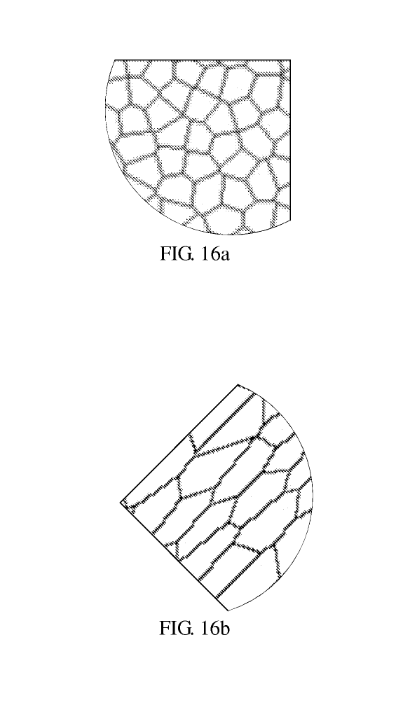

FIG. 15a and FIG. 15b are the schematic plan views of arrangements and shapes of the sensing electrode and driving electrode in accordance with several type of embodiments of the present disclosure. The independently disposed sensing electrodes are parallel to the first axis (X axis) and disposed equally spaced; the independently disposed driving electrodes are parallel to the second axis (Y axis) and disposed equally spaced. The sensing electrode and driving electrode of FIG. 15a are shaped as bars and arranged interlacingly and perpendicular to each other; the sensing electrode and driving electrode of FIG. 15b are shaped as diamonds and arranged interlacingly and perpendicular to each other.

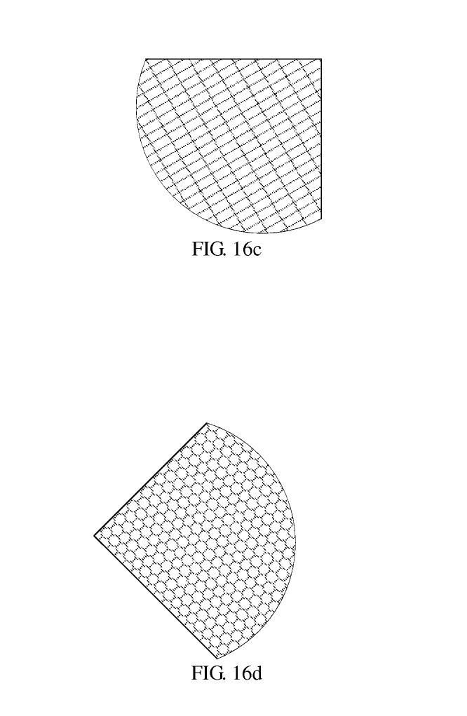

FIG. 16a, FIG. 16b, FIG. 16c and FIG. 16d are partially enlarged views correspond to part A of FIG. 15a or part B of FIG. 15b respectively in accordance with one embodiment.

The meshed conductive circuit in FIG. 16a and FIG. 16b is an irregular mesh; the manufacturing of the irregular meshed conductive circuit is simple, related processes are saved.

The meshed conductive circuit 140 of FIG. 16c and FIG. 16d is uniformly arranged regular patterns. The conductive mesh 11 is arranged uniformly and regularly, the mesh traces spaces d₁ are equal, on one hand, it makes the transmittance of the touch panel uniform; on the other hand, the surface resistance of the meshed conductive circuit is distributed uniformly, the resistance deviation is small, the settings for correcting the resistance bias are not needed to make the image uniform. The conductive mesh can be substantially orthogonal straight line lattice patterns, curved wavy line lattice patterns. The mesh cell of the meshed conductive circuit can be a regular graph, such as triangle, diamond or regular polygon etc.; it can also be an irregular graph.

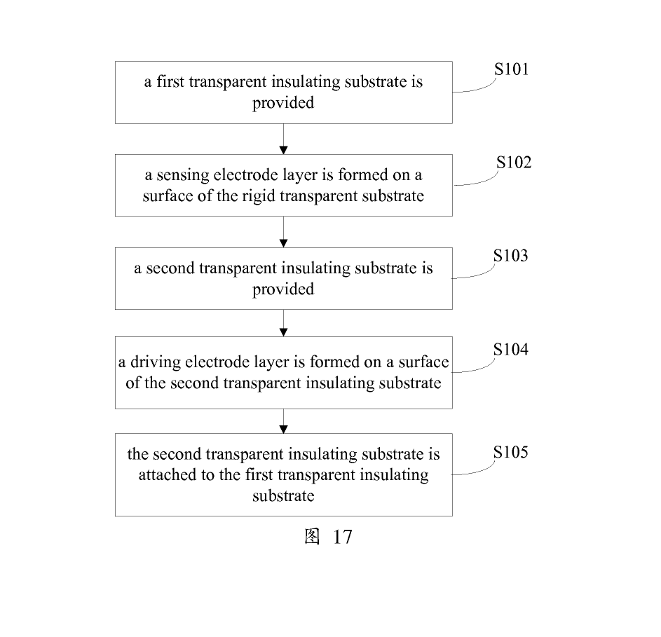

Referring to FIG. 17, it is a flowchart of the method of manufacturing a touch panel in accordance with one embodiment. Also referring to FIG. 3, the method includes the following steps.

Step S101: a first transparent insulating substrate is provided. The first transparent insulating substrate 110 is a rigid transparent insulating substrate or a flexible transparent insulating substrate; the rigid transparent insulating substrate can be the strengthened glass or flexible transparent panel. The flexible transparent panel is made of a material selected from a group consisting of the flexible polyethylene terephthalate (PET), polycarbonate (PC), polyethylene (PE), polyvinyl chloride (PVC), polypropylene (PP), polystyrene (PS) and polymethyl methacrylate acrylate (PMMA).

Step S102: a sensing electrode layer is formed on a surface of the rigid transparent substrate.

Step S103: a second transparent insulating substrate is provided. The second transparent insulating substrate 150 is a flexible transparent insulating substrate, it is made of a material selected from a group consisting of flexible polyethylene terephthalate (PET), polycarbonate (PC), polyethylene (PE), polyvinyl chloride (PVC), polypropylene (PP), polystyrene (PS) and polymethyl methacrylate methyl ester (PMMA). The second transparent insulating substrate 150 is a flexible thin film, it can be easily attached to the rigid first transparent insulating substrate 110.

Step S104: a driving electrode layer is formed on a surface of the second transparent insulating substrate.

There is not an order in the steps of S101 to S102 and steps of S103 to S104. It can be first to form the sensing electrode layer 120 on the first transparent insulating layer 140, it can also be first to form the driving electrode layer 140 on the second transparent insulating substrate 150, or they can be done at the same time.

Step S105: the second transparent insulating substrate is attached to the first transparent insulating substrate.

The way of attachment can be shown in FIG. 3, a surface which is provided with the driving electrode layer 140 of the second transparent insulating substrate 150 is attached to a surface which is provided with the sensing electrode layer 120 of the first transparent insulating substrate 110. It can also be shown in FIG. 11, a surface which is not provided with the driving electrode layer 240 of the second transparent insulating substrate 250 is attached to a surface which is provided with the sensing electrode layer 220 of the first transparent insulating substrate 210.

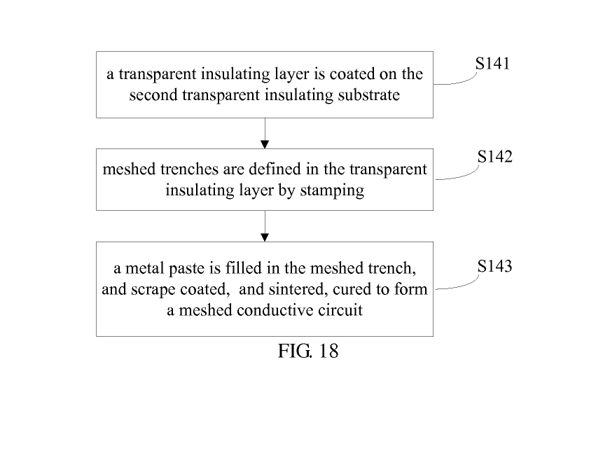

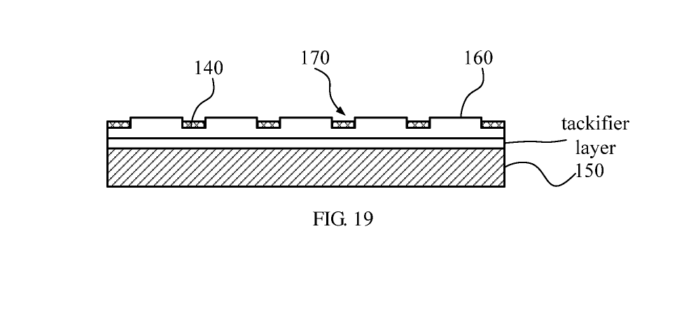

Referring to FIG. 18 and FIG. 19, the step S104 specifically includes:

Step S141: a transparent insulating layer is coated on the second transparent insulating substrate. The transparent insulating layer is preferably a UV (ultraviolet) adhesive. In order to increase the adhesive strength of the UV adhesive and the second transparent insulating substrate, a tackifier layer can be disposed between the second transparent insulating substrate 150 and the transparent insulating layer 160.

Step S142: meshed trenches are defined in the transparent insulating layer by stamping. Referring to FIG. 19, the transparent insulating layer 160 defines several meshed trenches 170 which have the same shape with the sensing electrode layer after mold pressing; the driving electrode layer 140 is formed in the meshed trench 170.

Step S143: a metal paste is filled in the meshed trench, and scrape coated and sintered, cured to form a meshed conductive circuit. The metal paste is filled in the meshed trench 170, and scrape coated to make the meshed trench fill with the metal paste, and then it is sintered, cured to form a conductive mesh. The metal paste is preferably nano silver paste. In the alternative embodiments, the metal which forms the meshed conductive circuit can be one selected from a group consisting of gold, silver, copper, aluminum, zinc, gold-plated silver and alloys of at least two above metals.

In the other embodiments, the meshed conductive circuit can also be manufactured by other process, for example, the meshed conductive circuit of the present disclosure is manufactured by photolithography.

Furthermore, referring to FIG. 14, it can also be that the transparent panel 470 is formed on the first transparent insulating substrate 410. The transparent panel 470 can be a strengthened glass plate or a flexible transparent plate.

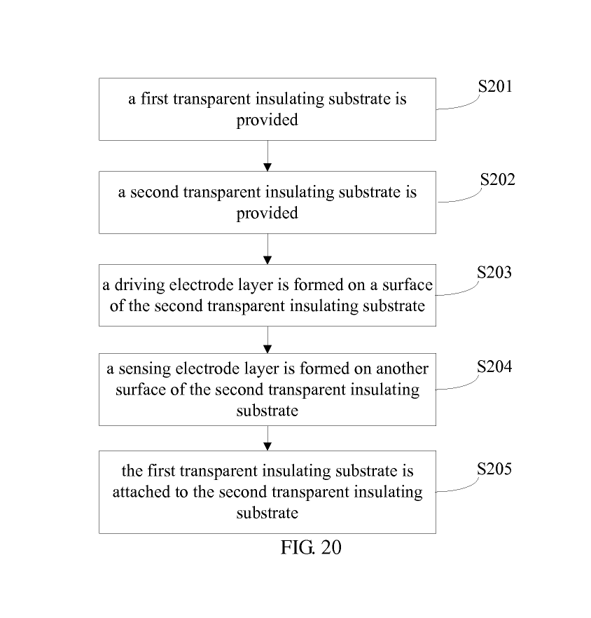

Referring to FIG. 20, it is a flowchart of a method of manufacturing the touch panel in accordance with another embodiment. Referring also to FIG. 13, the method includes the following steps.

Step S201: a first transparent insulating substrate is provided. The first transparent insulating substrate 310 is a rigid transparent insulating substrate or a flexible transparent insulating substrate; the rigid transparent insulating substrate can be a strengthened glass plate or flexible transparent panel. The flexible transparent panel is made of a material selected from a group consisting of the flexible polyethylene terephthalate (PET), polycarbonate (PC), polyethylene (PE), polyvinyl chloride (PVC), polypropylene (PP), polystyrene (PS) and polymethyl methacrylate acrylate (PMMA).

Step S202: a second transparent insulating substrate is provided. The second transparent insulating substrate 350 is a flexible transparent insulating substrate, it is made of a material selected from a group consisting of flexible polyethylene terephthalate (PET), polycarbonate (PC), polyethylene (PE), polyvinyl chloride (PVC), polypropylene (PP), polystyrene (PS) and polymethyl methacrylate methyl ester (PMMA). The second transparent insulating substrate 350 is a flexible thin film, it can be easily attached to the first transparent insulating substrate 310.

Step S203: a driving electrode layer is formed on a surface of the second transparent insulating substrate.

Step S204: a sensing electrode layer is formed on another surface of the second transparent insulating substrate.

A sequence between step S203 and step S204 is arbitrary. It can be first to form the sensing electrode layer 320 on the first transparent insulating layer 140, it can also be first to form the driving electrode layer 340 on the second transparent insulating substrate 350.

Step S205: the first transparent insulating substrate is attached to the second transparent insulating substrate.

The way of attachment is specifically that the first transparent insulating substrate 310 is attached to a surface which is not provided with the sensing electrode layer 320 of the second transparent insulating substrate 350.

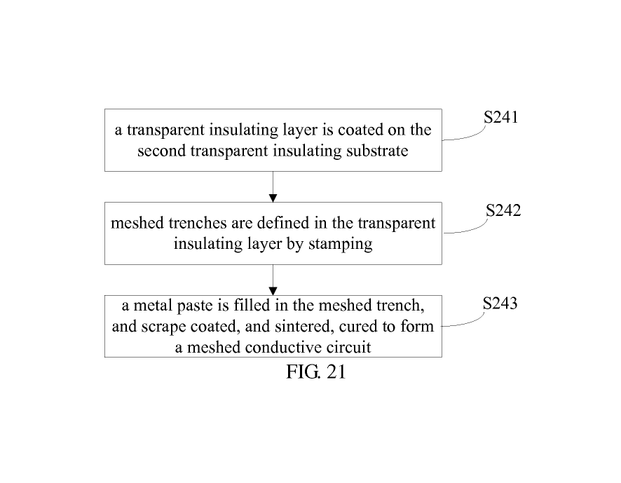

Referring to FIG. 19 to FIG. 21, the step S204 specifically includes:

Step S241: a transparent insulating layer is coated on the second transparent insulating substrate. The transparent insulating layer 160 is preferably a UV (ultraviolet) adhesive. In order to increase the adhesive strength of the UV adhesive and the flexible insulating substrate, a tackifier layer can be disposed between the second transparent insulating substrate 150 and the transparent insulating layer 160.

Step S242: meshed trenches are defined in the transparent insulating layer by stamping. Referring to FIG. 19, the transparent insulating layer 160 defines several meshed trenches 170 which have the same shape with the driving electrode after mold pressing; the driving electrode layer 140 is formed in the meshed trench 170.

Step S243: a metal paste is filled in the meshed trench, and scrape coated, coated and sintered, cured to form a meshed conductive circuit. The metal paste is filled in the meshed trench 170, and scrape coated, coated to make the meshed trench fill with the metal paste, and then it is sintered, cured to form a conductive mesh. The metal paste is preferably nano silver paste. In the alternative embodiments, the metal which forms the meshed conductive circuit can be one selected from a group consisting of gold, silver, copper, aluminum, zinc, gold-plated silver and alloys of at least two above metals.

In the alternative embodiments, the meshed conductive circuit can also be manufactured by other process, for example, the meshed conductive circuit of the present disclosure is manufactured by photolithography.

Furthermore, it can also be that the transparent panel is formed on the first transparent insulating substrate. The transparent panel can be a strengthened glass plate or a flexible transparent panel.

The driving electrode of the touch panel is manufactured to the conductive grid formed by the meshed conductive circuit in the above method, the touch panel do not have the problems such as the surface is easy to be scratched or peeled off, the cost is high, the surface resistance is high for the large size panel when the ITO film is used, so the cost of the touch panel is low, the sensitivity is higher.

Although the present disclosure has been described with reference to the embodiments thereof and the best modes for carrying out the present disclosure, it is apparent to those skilled in the art that a variety of modifications and changes may be made without departing from the scope of the present disclosure, which is intended to be defined by the appended claims.

1-38. (canceled)

39. A touch panel, comprising:
a first transparent insulating substrate;
a second transparent insulating substrate comprising a first surface facing the first transparent insulating substrate and a second surface opposite to the first surface;
a sensing electrode layer disposed between the first transparent insulating substrate and the second insulating substrate, the sensing electrode layer comprising a plurality of independently disposed sensing electrodes; and
a driving electrode layer disposed on the first surface or the second surface of the second transparent insulating layer, the driving electrode layer comprising a plurality of independently disposed driving electrodes, each of the driving electrodes comprising a meshed conductive circuit.

40. The touch panel according to claim 39, wherein a mesh spacing of the meshed conductive circuit is defined as d₁, and 100 μm≦d<600 μm; a surface resistance of the meshed conductive circuit is defined as R, and 0.1 Ω/sq≦R<200 Ω/sq.

41. The touch panel according to claim 39, further comprising a transparent insulating layer formed on a surface of the second transparent insulating substrate, wherein the meshed conductive circuit is embedded or buried in the transparent insulating layer.

42. The touch panel according to claim 41, wherein the transparent insulating layer defines a plurality of interlaced meshed trenches, the meshed conductive circuit is received in the meshed trenches.

43. The touch panel according to claim 39, wherein the first transparent insulating substrate is a rigid substrate, the second transparent insulating substrate is a flexible substrate.

44. The touch panel according to claim 43, wherein the first rigid transparent insulating substrate is a strengthened glass, the second flexible transparent insulating substrate is made of a material selected from a group consisting of polyethylene terephthalate, polycarbonate, polyethylene, polyvinyl chloride, polypropylene, polystyrene, and polymethyl methacrylate.

45. The touch panel according to claim 39, wherein the first transparent insulating substrate is a flexible substrate, the second transparent insulating substrate is a rigid substrate or a flexible substrate.

46. The touch panel according to claim 45, further comprising a transparent panel attached to a surface of the first transparent insulating substrate.

47. The touch panel according to claim 46, wherein the transparent panel is a strengthened glass panel or a flexible transparent touch panel.

48. The touch panel according to claim 39, further comprising an adhesive layer, wherein the adhesive layer is formed between the first transparent insulating substrate and the second transparent insulating substrate.

49. The touch panel according to claim 48, wherein the adhesive layer is an optically transparent OCA or a LOCA.

50. The touch panel according to claim 39, wherein the sensing electrode layer is made of a material selected from a group consisting of indium tin oxide, antimony tin oxide, indium zinc oxide, zinc aluminum, and polyethylene dioxythiophene.

51. The touch panel according to claim 39, wherein a mesh of the meshed conductive circuit is a regular geometric mesh.

52. The touch panel according to claim 39, wherein a mesh of the meshed conductive circuit is an irregular geometric mesh.

53. The touch panel according to claim 39, wherein the meshed conductive circuit is made of silver, a mesh traces spacing of the meshed conductive circuit ranges from 200 μm to 500 μm; a surface resistance of the meshed conductive circuit is defined as R, and 4 Ω/sq≦R<50 Ω/sq, a coating amount of silver ranges from 0.7 g/m to 1.1 g/m.

54. The touch panel according to claim 39, wherein the meshed conductive circuit is made of a material selected from a group consisting of gold, silver, copper, aluminum, zinc, gold-plated silver and alloys of at least two above metals.

55. The touch panel according to claim 41, wherein the transparent insulating layer can be formed by curing a light curing glue, thermosetting adhesive or air-drying adhesive.

56. A touch panel, comprising:
a rigid transparent insulating substrate;
a sensing electrode layer formed on a surface of the rigid transparent insulating substrate, the sensing electrode layer comprising a plurality of independently disposed sensing electrodes;
a flexible transparent insulating substrate comprising a first surface and a second surface opposite to the first surface, and
a driving electrode layer formed on the first surface or the second surface of the flexible transparent insulating substrate, the sensing electrode layer comprising a plurality of independently disposed driving electrodes, each driving electrode of the driving electrode layer comprising a meshed conductive circuit;
wherein the first surface or the second surface of the flexible transparent insulating substrate is attached to the rigid transparent insulating substrate.

57. The touch panel according to claim 56, wherein a mesh spacing of the meshed conductive circuit is defined as d₁, and 100 μm≦d<600 μm; a surface resistance of the meshed conductive circuit is defined as R, and 0.1 Ω/sq≦R<200 Ω/sq.

58. The touch panel according to claim 56, further comprising a transparent insulating layer formed on a surface of the flexible transparent insulating substrate, the meshed conductive circuit is embedded or buried in the transparent insulating layer.

59. The touch panel according to claim 58, wherein the transparent insulating layer defines a plurality of interlaced meshed trench, the meshed conductive circuit is received in the meshed trench.

60. The touch panel according to claim 56, wherein the rigid transparent insulating substrate is a strengthened glass, the flexible transparent insulating substrate is made of a material selected from a group consisting of flexible polyethylene terephthalate, polycarbonate, polyethylene, polyvinyl chloride, polypropylene, polystyrene and polymethyl methacrylate.

61. The touch panel according to claim 56, wherein the sensing electrode is made of transparent indium tin oxide.

62. The touch panel according to claim 56, wherein a mesh of the meshed conductive circuit is a regular geometric mesh.

63. The touch panel according to claim 56, wherein a mesh of the meshed conductive circuit is an irregular geometric mesh.

64. The touch panel according to claim 62, wherein a cell of the mesh is a single triangle, diamond and regular polygon.

65. A method of manufacturing a touch panel, comprising the following steps:
providing a transparent insulating substrate;
forming a sensing electrode layer on a surface of the first transparent insulating substrate;
providing a second transparent insulating substrate;
forming a driving electrode layer on a surface of the second transparent insulating substrate; a driving electrode of the driving electrode layer is a meshed conductive circuit which comprises a plurality of mesh cells; and
attaching the second transparent insulating substrate to the first transparent insulating substrate.

66. The method according to claim 65, wherein the formation of the driving electrode layer on a surface of the second transparent insulating substrate specifically comprises:
coating a transparent insulating layer on the second transparent insulating substrate;
defining a meshed trench on the transparent insulating layer by stamping;
forming a meshed conductive circuit in the meshed trench.

67. The method according to claim 66, wherein the formation of the meshed conductive circuit in the meshed trench specifically comprises: filling a metal paste to the meshed trench, and scrape coating, sintering and curing the metal paste.

68. The method according to claim 65, wherein steps of attaching the second transparent insulating substrate to the first transparent insulating substrate are: attaching a surface forming with the driving electrode layer of the second transparent insulating substrate to a surface forming with the sensing electrode layer of the first transparent insulating substrate; or attaching a surface forming without the driving electrode layer of the second transparent insulating substrate to a surface forming with the sensing electrode layer of the first transparent insulating substrate.

69. The method according to claim 65, further comprising: forming a transparent panel on a surface of the first transparent insulating substrate.

70. The method according to claim 69, wherein the transparent panel is a strengthened glass panel or a flexible transparent panel.
